(19) United States
(12) Patent Application Publication
(10) Pub. No.: US 2024/0140313 A1
(43) Pub. Date: May 2, 2024

(54) Wireless Vehicular Security Camera System

(71) Applicant: Sean Bellamy, South Ozone Park, NY (US)

(72) Inventor: Sean Bellamy, South Ozone Park, NY (US)

(21) Appl. No.: 17/973,678

(22) Filed: Oct. 26, 2022

(51) Int. Cl. B60R 1/27; B60R 1/29; B60R 11/04; H04N 5/225; H04N 5/232; H04N 5/247

(52) U.S. Cl. CPC B60R 1/27; B60R 1/29; B60R 11/04; H04N 5/2252; H04N 5/23206; H04N 5/247; B60R 2011/0005

(57) ABSTRACT

A wireless vehicular security camera system for mounting to a vehicle dashboard includes a vehicle having a dashboard and a housing including a top wall, a bottom wall, and a perimeter wall. A plurality of cameras is mounted on the top wall and records a 360° range of view of an exterior and an interior of the vehicle. A mounting member is attached to the bottom wall and secures the housing to the dashboard. A control circuit is electrically coupled to the cameras and is positioned within the housing. A motion sensor is electrically coupled to the control circuit and actuates the cameras when the motion sensor detects movement. A transmitter is electrically coupled to the control circuit and wirelessly communicates with an electronic device.

### CROSS-REFERENCE TO RELATED APPLICATIONS

Not Applicable

### STATEMENT REGARDING FEDERALLY SPONSORED RESEARCH OR DEVELOPMENT

Not Applicable

### The Names of the Parties to a Joint Research Agreement

Not Applicable

### Incorporation-by-Reference of Material Submitted on a Compact Disc or as a Text File Via the Office Electronic Filing System

Not Applicable

### Statement Regarding Prior Disclosures by the Inventor or Joint Inventor

Not Applicable

### BACKGROUND OF THE INVENTION

### (1) Field of the Invention

The disclosure relates to video cameras and more particularly pertains to a new video camera for recording an interior and exterior of a vehicle.

### (2) Description of Related Art Including Information Disclosed Under 37 CFR 1.97 and 1.98

The prior art relates to video cameras and includes a variety of video cameras being mounted to a vehicle and recording an exterior of the vehicle. Known prior art does not allow a video camera to record the exterior and an interior of the vehicle simultaneously and be in wireless communication with an electronic device.

### BRIEF SUMMARY OF THE INVENTION

An embodiment of the disclosure meets the needs presented above by generally comprising a vehicle having a dashboard and a housing including a top wall, a bottom wall, and a perimeter wall. A plurality of cameras is mounted on the top wall and records a 360° range of view of an exterior and an interior of the vehicle. A mounting member is attached to the bottom wall and removably secures the housing to the dashboard. A control circuit is electrically coupled to the cameras and is positioned within the housing. A motion sensor is electrically coupled to the control circuit and actuates the cameras when the motion sensor detects movement. A transmitter is electrically coupled to the control circuit and is configured for wirelessly communicating with an electronic device.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top isometric view of a wireless vehicular security camera system according to an embodiment of the disclosure.

FIG. 2 is a bottom isometric view of an embodiment of the disclosure.

FIG. 3 is a front view of an embodiment of the disclosure.

FIG. 4 is an in-use view of an embodiment of the disclosure.

FIG. 5 is an in-use view of an embodiment of the disclosure.

### DETAILED DESCRIPTION OF THE INVENTION

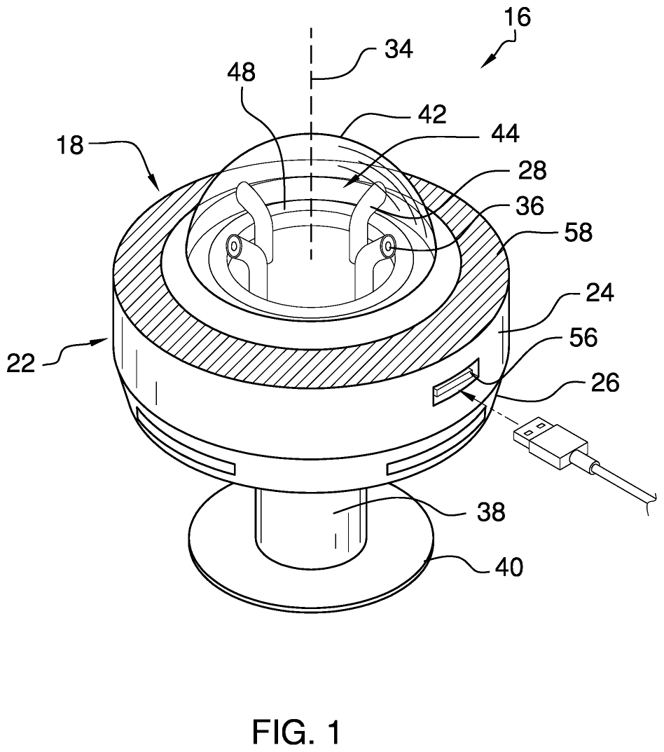

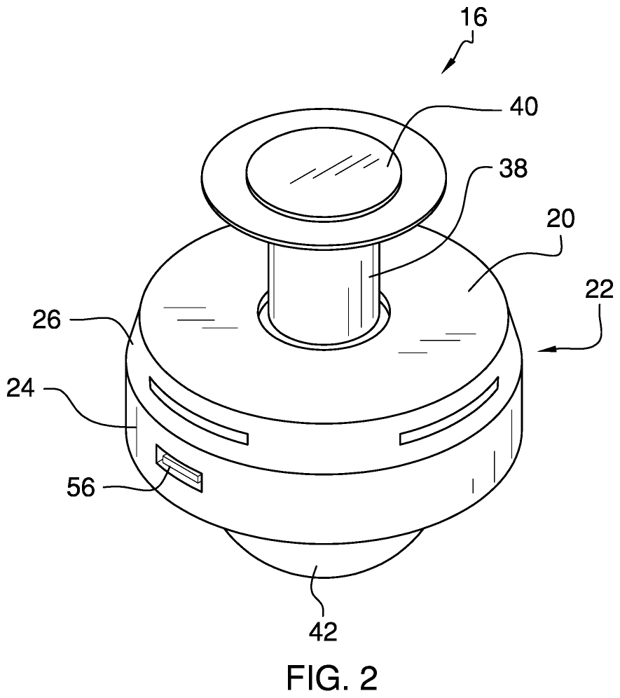

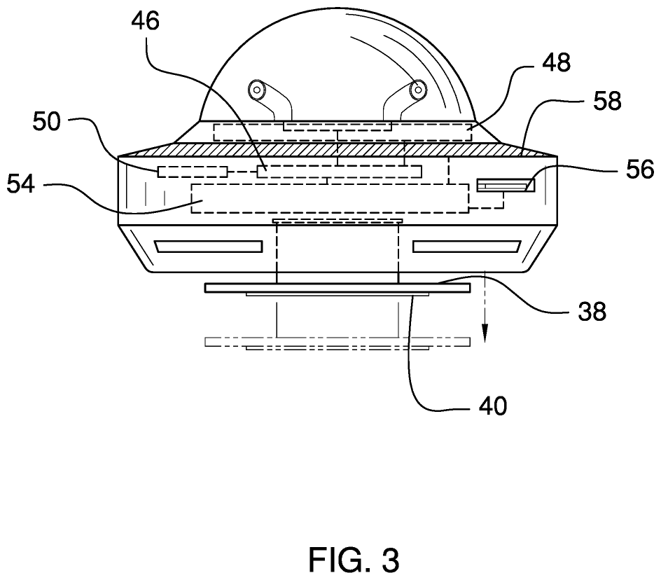

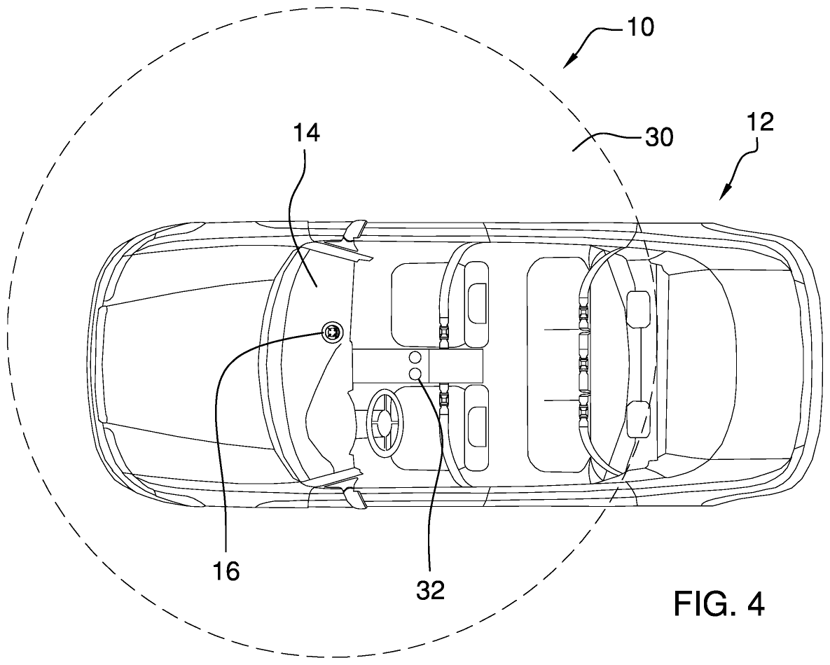

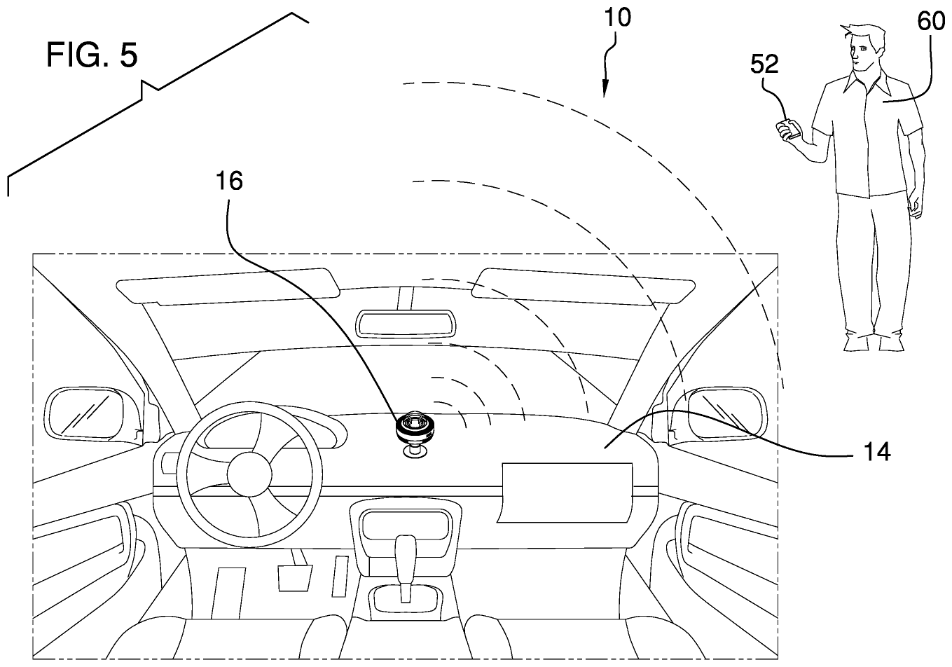

With reference now to the drawings, and in particular to FIGS. 1 through 5 thereof, a new video camera embodying the principles and concepts of an embodiment of the disclosure and generally designated by the reference numeral 10 will be described.

As best illustrated in FIGS. 1 through 5, the wireless vehicular security camera system 10 generally comprises a vehicle 12 having a dashboard 14. A housing 16 has a top wall 18, a bottom wall 20, and a perimeter wall 22. The perimeter wall 22 may include an upper perimeter wall 24 and a lower perimeter wall 26 and the lower perimeter wall 26 may be angled relative to the upper perimeter wall 24. A plurality of cameras 28 is mounted on the top wall 18 and records a 360° range of view of an exterior 30 and an interior 32 of the vehicle 12. The cameras 28 are equally spaced about a vertical axis 34 of the housing 16 and each of the cameras 28 has a lens 36 positioned facing away from the vertical axis 34. The cameras 28 will typically comprise four cameras equally spaced from each other.

A mounting member 38 is attached to the bottom wall 20 and removably secures the housing 16 to the dashboard 14. The mounting member 38 may comprise a magnetic disc 40. The mounting member 38 will typically be extendable and retractable to adjust a height of the housing 16 relative to the dashboard 14. A dome 42 is mounted on the top wall 18 and encloses the cameras 28 in an interior space 44 to protect each camera 28 from external damage. The dome 42 normally comprises a transparent material and has a semi-spherical shape.

A control circuit 46 is electrically coupled to the cameras 28 and is positioned within the housing 16. A motion sensor 48 is electrically coupled to the control circuit 46 and actuates the cameras 28 when the motion sensor 48 detects movement. The motion sensor 48 is attached to the top wall 18 and is positioned within the interior space 44 contained between the top wall 18 and the dome 42. A transmitter 50 is electrically coupled to the control circuit 46 and is configured for wirelessly communicating with an electronic device 52 such as a mobile phone. The transmitter 50 is positioned within the housing 16.

A power supply 54 is electrically coupled to the control circuit 46 and is positioned within the housing 16. The power supply 54 typically comprises a rechargeable battery. A charging port 56 is positioned on the upper perimeter wall 24 and is electrically coupled to the rechargeable battery. A plurality of solar panels 58 is electrically coupled to the power supply 54 and the solar panels 58 are mounted on the top wall 18 and are positioned adjacent to the perimeter wall 22.

In use, the mounting member 38 is removably secured to the dashboard 14 of the vehicle 12. The plurality of cameras 28 records a 360° range of view of the exterior 30 and the interior 32 of the vehicle 12. The plurality of cameras 28 is actuated to record when the motion sensor 48 detects movement, typically detecting movement proximate to the vehicle 12. The transmitter 50 wirelessly communicates with the electronic device 52 such that a user 60 of the electronic device 52 can view the recoding from each of the cameras 28.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A vehicular camera system comprising:
a vehicle having a dashboard;
a housing having a top wall, a bottom wall, and a perimeter wall;
a plurality of cameras being mounted on said top wall and recording a 360° range of view of an exterior and an interior of said vehicle;
a mounting member being attached to said bottom wall and removably securing said housing to said dashboard;
a control circuit being electrically coupled to said cameras and being positioned within said housing;
a motion sensor being electrically coupled to said control circuit and actuating said cameras when said motion sensor detects movement; and
a transmitter being electrically coupled to said control circuit and being configured for wirelessly communicating with an electronic device.

2. The vehicular camera system of claim 1, wherein said perimeter wall includes an upper perimeter wall and a lower perimeter wall, said lower perimeter wall being angled relative to said upper perimeter wall.

3. The vehicular camera system of claim 1, wherein said cameras are equally spaced about a vertical axis of said housing, each of said cameras having a lens positioned facing away from said vertical axis.

4. The vehicular camera system of claim 3, wherein said cameras comprise four cameras being equally spaced from each other.

5. The vehicular camera system of claim 1, wherein said mounting member comprises a magnetic disc, said mounting member being extendable and retractable to adjust a height of said housing relative to said dashboard.

6. The vehicular camera system of claim 1, further including a dome being mounted on said top wall and enclosing said cameras in an interior space to protect each camera from external damage, said dome comprising a transparent material having a semi-spherical shape.

7. The vehicular camera system of claim 6, wherein said motion sensor is attached to said top wall and is positioned within said interior space contained between said top wall and said dome.

8. The vehicular camera system of claim 1, wherein said transmitter is positioned within said housing.

9. The vehicular camera system of claim 1, further including a power supply being electrically coupled to said control circuit and being positioned within said housing, said power supply comprising a rechargeable battery.

10. The vehicular camera system of claim 9, further including a charging port being positioned on said upper perimeter wall and being electrically coupled to said rechargeable battery.

11. The vehicular camera system of claim 1, further including a plurality of solar panels being electrically coupled to said power supply, said solar panels being mounted on said top wall and being positioned adjacent to said perimeter wall.

12. A vehicular camera system comprising:
a vehicle having a dashboard;
a housing having a top wall, a bottom wall, and a perimeter wall, said perimeter wall including an upper perimeter wall and a lower perimeter wall, said lower perimeter wall being angled relative to said upper perimeter wall;
a plurality of cameras being mounted on said top wall and recording a 360° range of view of an exterior and an interior of said vehicle, said cameras being equally spaced about a vertical axis of said housing, each of said cameras having a lens positioned facing away from said vertical axis, said cameras comprising four cameras being equally spaced from each other;
a mounting member being attached to said bottom wall and removably securing said housing to said dashboard, said mounting member comprising a magnetic disc, said mounting member being extendable and retractable to adjust a height of said housing relative to said dashboard;
a dome being mounted on said top wall and enclosing said cameras in an interior space to protect each camera from external damage, said dome comprising a transparent material having a semi-spherical shape;
a control circuit being electrically coupled to said cameras and being positioned within said housing;
a motion sensor being electrically coupled to said control circuit and actuating said cameras when said motion sensor detects movement, said motion sensor being attached to said top wall and being positioned within said interior space contained between said top wall and said dome;
a transmitter being electrically coupled to said control circuit and being configured for wirelessly communicating with an electronic device, said transmitter being positioned within said housing;
a power supply being electrically coupled to said control circuit and being positioned within said housing, said power supply comprising a rechargeable battery;
a charging port being positioned on said upper perimeter wall and being electrically coupled to said rechargeable battery; and
a plurality of solar panels being electrically coupled to said power supply, said solar panels being mounted on said top wall and being positioned adjacent to said perimeter wall.
